(19) United States
(12) Patent Application Publication
(10) Pub. No.: US 2015/0335034 A1
(43) Pub. Date: Nov. 26, 2015

(54) BAKE WARE FOR CREATING DIFFERENT SHAPED MOLDS

(71) Applicant: Buyar Hayrula, Freehold, NJ (US)

(72) Inventor: Buyar Hayrula, Freehold, NJ (US)

(21) Appl. No.: 14/716,847

(22) Filed: May 19, 2015

Related U.S. Application Data
(60) Provisional application No. 62/001,721, filed on May 22, 2014.

(51) Int. Cl. A21B 3/13

(52) U.S. Cl. CPC A21B 3/132

(57) ABSTRACT

An interchangeable baking device for creating different baking molds is provided. The present invention includes a support device having a first support plate and a second support plate. The first and second support plates each include a top end, a bottom, and a substantially flat front surface. A clip is formed at the top end of each of the first and second support plates. The present invention further includes baking plates having a substantially flat body. The baking plates may be secured in an upright position within the first and second clips forming a baking enclosure in between the baking plates.

### CROSS-REFERENCE TO RELATED APPLICATION

This application claims the benefit of priority of U.S. provisional application No. 62/001,721, filed May 22, 2014, the contents of which are herein incorporated by reference.

### BACKGROUND OF THE INVENTION

The present invention relates to baking and, more particularly, to interchangeable bake ware.

Baking different shaped foods (cake, bread, brownies, etc.) requires purchasing different molds or using a knife to cut the food to the desired shape and dimension. Purchasing multiple molds is costly and using a knife can lead to errors and waste. Multiple molds also require a significant amount of storage space.

As can be seen, there is a need for an interchangeable bake ware for creating different shaped molds.

### SUMMARY OF THE INVENTION

In one aspect of the present invention, an interchangeable baking device comprises: a first support plate having a top end and a bottom and comprising a substantially flat front surface, wherein a first clip is formed at the top end; a second support plate connectable to the first support plate and having a top end and a bottom and comprising a substantially flat front surface, wherein a second clip is formed at the top end; and at least one baking plate comprising a substantially flat body and securable in an upright position within the first and second clips forming a baking enclosure.

In another aspect of the present invention, a method of forming an interchangeable baking mold comprises: providing a plurality of supporting devices each comprising at least one clip; providing a plurality of baking plates; and securing the baking plates to the clips of the supporting devices so that the baking plates are in an upright position, and forming a baking enclosure in between the baking plates.

These and other features, aspects and advantages of the present invention will become better understood with reference to the following drawings, description and claims.

### BRIEF DESCRIPTION OF THE DRAWINGS

FIG. 1 is a perspective detail view of the present invention shown in exemplary usage;

FIG. 2 is a perspective view of a component assembly of the present invention.

FIG. 3 is an exploded detail view of a component assembly of the present invention;

FIG. 4 is a top view of a component assembly of the present invention;

FIG. 5 is a perspective view of an exemplary baking plate of the present invention;

FIG. 6 is a perspective view of an exemplary baking plate of the present invention;

FIG. 7 is a perspective view of an exemplary baking plate of the present invention;

FIG. 8 is a perspective view of an exemplary baking plate of the present invention;

FIG. 9 is a perspective view of an exemplary baking plate of the present invention;

FIG. 10 is a perspective view of an exemplary baking plate of the present invention;

FIG. 11 is a perspective view of an exemplary baking plate of the present invention;

FIG. 12 is a perspective view of an exemplary baking plate of the present invention;

FIG. 13 is a perspective view of an exemplary baking plate of the present invention;

FIG. 14 is a perspective view of an exemplary baking plate of the present invention;

FIG. 15 is a perspective view of an exemplary baking plate of the present invention;

FIG. 16 is a perspective view of an exemplary baking plate of the present invention;

FIG. 17 is a perspective view of an exemplary baking plate of the present invention;

FIG. 18 is a perspective view of an exemplary baking plate of the present invention;

FIG. 19 is a perspective view of an exemplary baking plate of the present invention;

FIG. 20 is a perspective view of an exemplary baking plate of the present invention;

FIG. 21 is a perspective view of an exemplary baking plate of the present invention;

FIG. 22 is a perspective view of an exemplary baking plate of the present invention;

FIG. 23 is a perspective view of an exemplary baking plate of the present invention;

FIG. 24 is a perspective view of an exemplary baking plate of the present invention;

FIG. 25 is a perspective view of an exemplary baking plate of the present invention;

FIG. 26 is a perspective view of an exemplary baking plate of the present invention;

FIG. 27 is a perspective view of an exemplary baking plate of the present invention;

FIG. 28 is a perspective view of an exemplary baking plate of the present invention;

FIG. 29 is a perspective view of an exemplary baking plate of the present invention; and

FIG. 30 is a top view of an exemplary configuration of the present invention demonstrating usage with curved and straight baking plates.

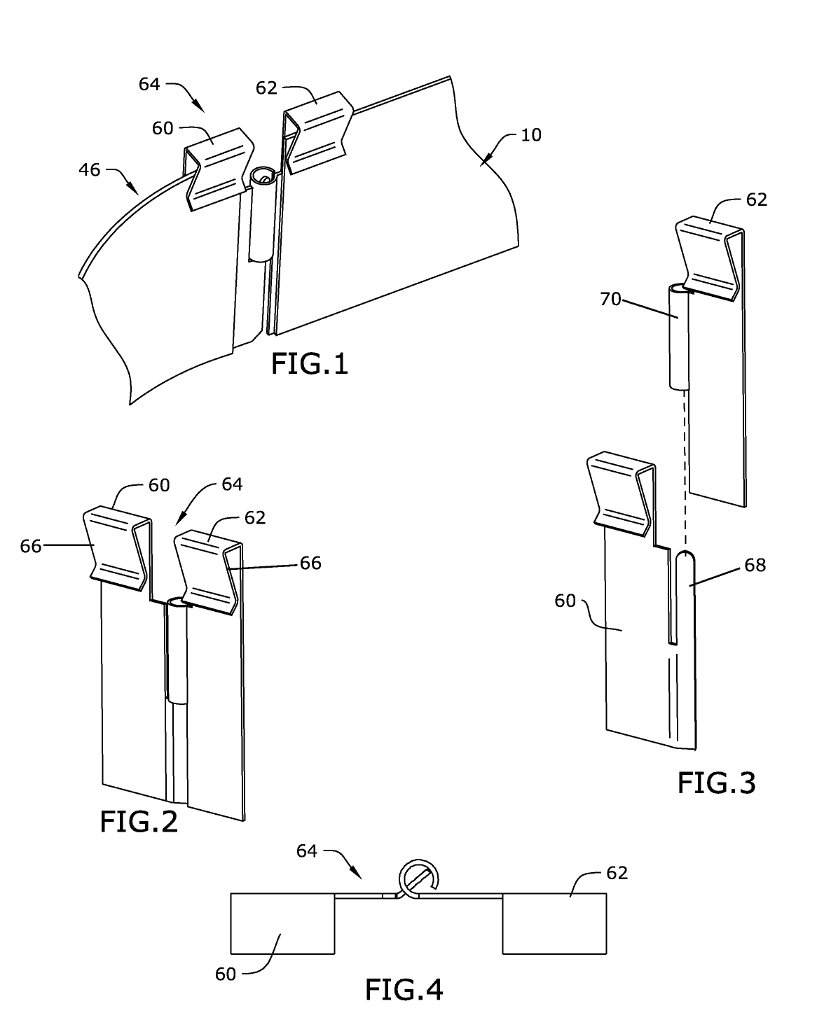

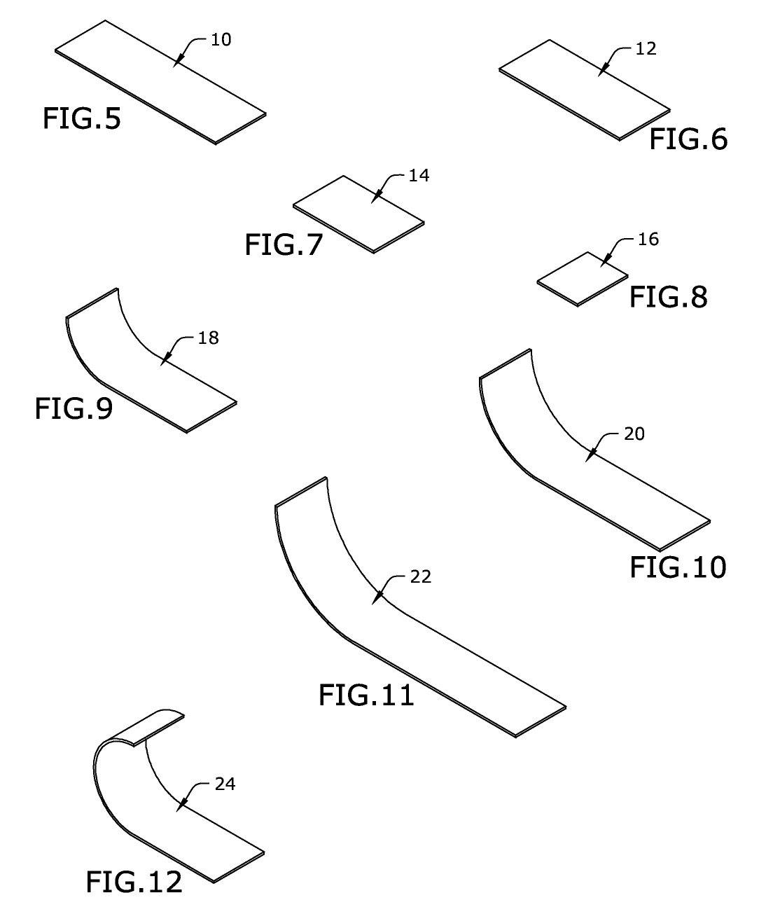

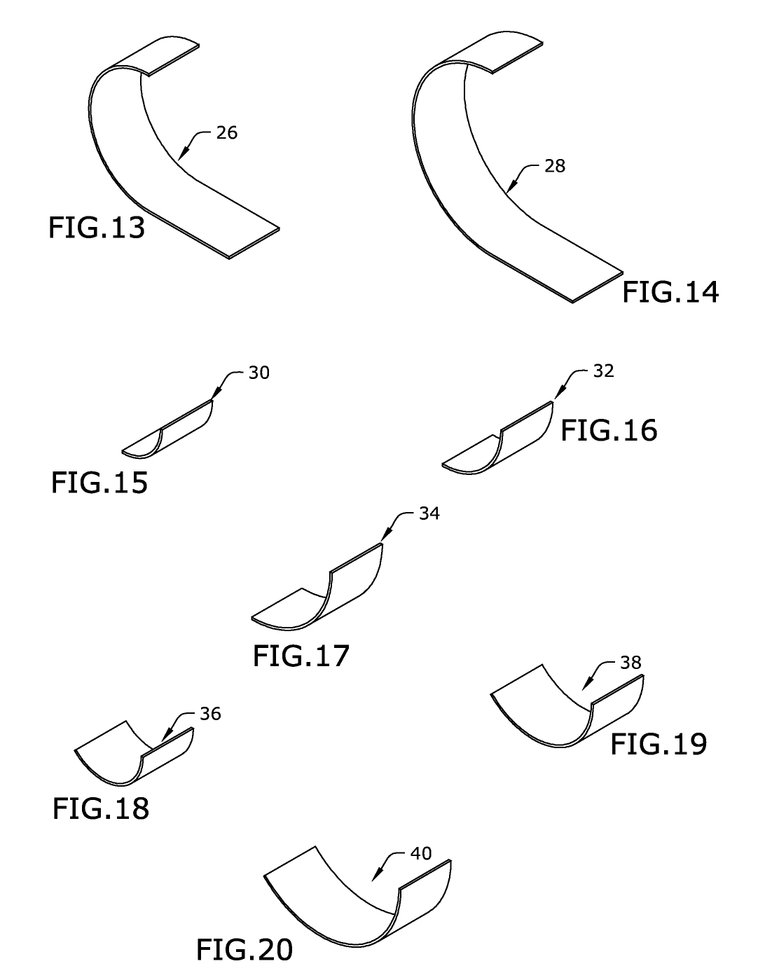

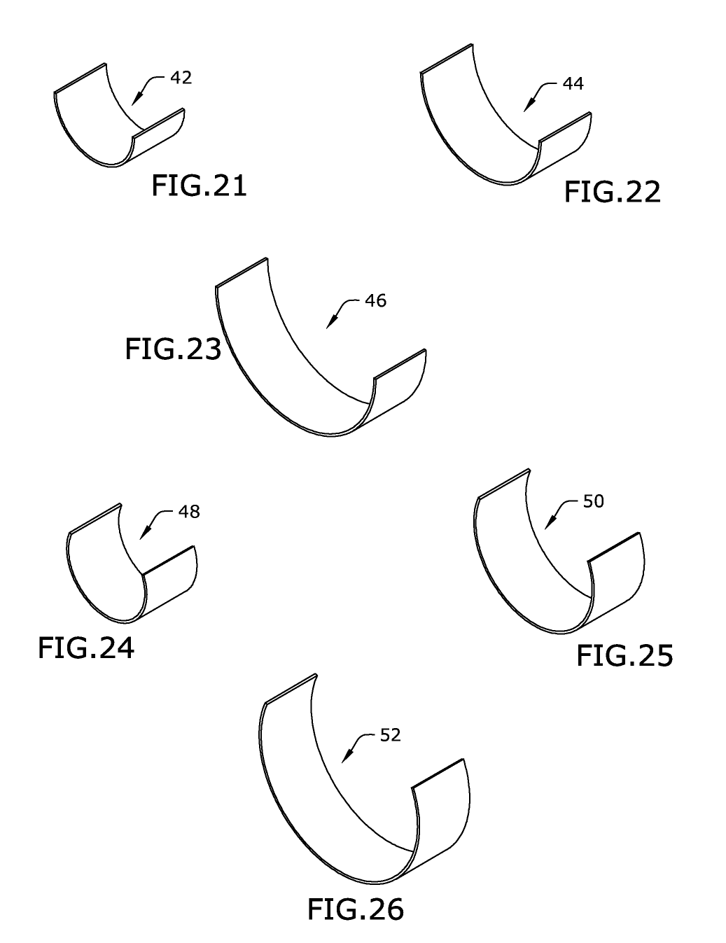

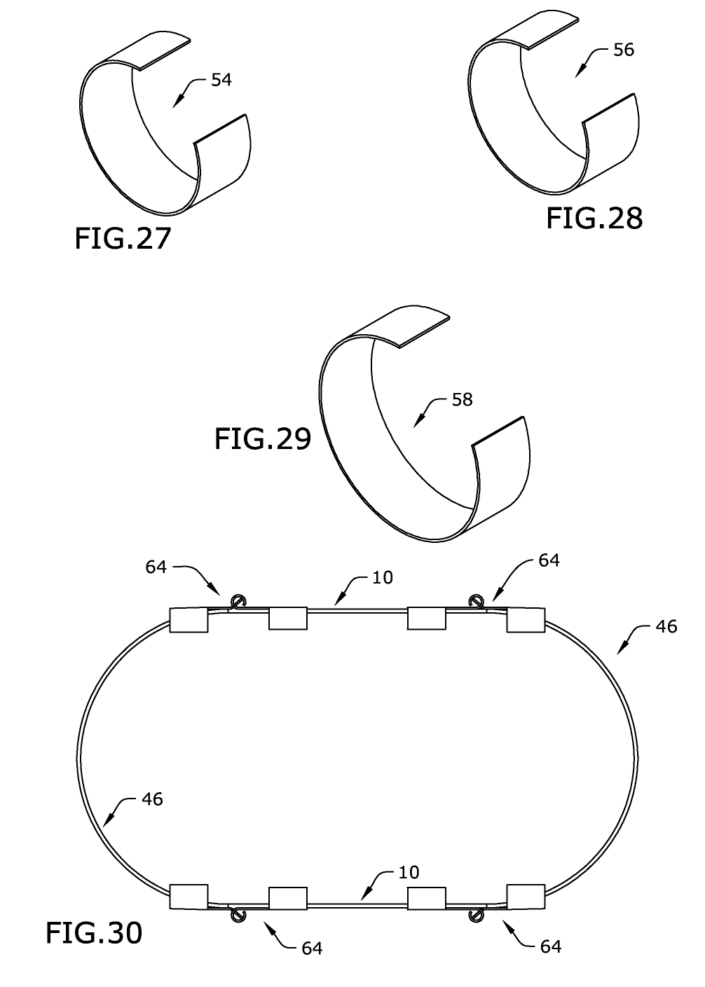

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes various shaped bottomless bake ware that connects with clips and hinges to form different shapes. The present invention connects partial bottomless shapes of various lengths at different angles. This allows the user to create a shape without having to using a knife and spend money on different molds. The final result is a baked good made to the exact shape and design desired without having waste. The product disconnects and fits in a container which saves storage space and can be used again in the future for different designs.

Referring to the Figures, the present invention includes an interchangeable baking device for creating different baking molds. The present invention includes a support device 64 having a first support plate 60 and a second support plate 62. The first and second support plates 60, 62 each include a top end, a bottom, and a substantially flat front surface. A clip 66 is formed at the top end of each of the first and second support plates 60, 62. The first support plate 60 and the second support plate 62 are connectable such that the front surface of the first support plate 60 is planar with the front surface of the second support plate 62. The present invention further includes at least one baking plate 10 having a substantially flat body. A plurality of baking plates 10, 46 may be secured in an upright position within the first and second clips 66 forming a baking enclosure in between the baking plates 10, 46.

In certain embodiments, the first and second support plates 60, 62 are releasably connectable by a hinge 68, 70. Therefore, the plates 60, 62 may be detached for easy storage. In such embodiments, the first support plate 60 includes a peg 68 extending from a side and away from the front surface. The second support plate 62 may include a receiver 70 extending from an adjacent side to the side of the first support plate 60 and extending away from the front surface. Since the peg 68 and the receiver 70 extend away from respective front surfaces, the first and second support plates 60, 62 may connect together so that the front surfaces are planar relative to one another.

As mentioned above, the first and second support plates 60, 62 each include a clip 66 formed at the top ends. In certain embodiments, the clip 66 may extend from a top edge of each of the support plates 60, 62. The clip 66 may then extend partially downward toward the bottom of the support plates 60, 62. The clip 66 may bend towards the front surface leaving a space in between a bottom end of the clip 66 and the front surface. The baking plates 10, 46 may snuggly fit in between the space in between the clip 66 and the front surface so that the clip 66 resiliently retains the baking plates 10, 46 within.

The plurality of baking plates 10, 46 may include a plurality of curved plates 46 and a plurality of flat plates 10. The plates 10, 46 may be interchanged and attached to the supporting devices to create different shapes and sizes to form different baking enclosures. The plurality of curved plates 46 may each include a different radius of curvature, and the plurality of flat plates 10 may each include a different length. An example of different curved and flat plates 10, 46 may include the following: 2″ flat plate 10; 4″ flat plate 12; 6″ flat plate 14; 8″ flat plate 16; 4″ curved plate 18; 6″ curved plate 20; 8″ curved plate 22; 4″ J-shape plate 24; 6″ J shape plate 26; 8″ J shape plate 28; 4″¼ circle 30; 6″¼ circle 32; 8″¼ circle 34; 4″⅜ circle 36; 6″⅜ circle 38; 8″⅜ circle 40; 4″½ circle 42; 6″½ circle 44; 8″½ circle 46; 4″⅝ circle 48; 6″⅝ Circle 50; 8″⅝ circle 52; 4″¾ circle 54; 6″¾ circle 56; and 8″¾ circle 58.

The various bottomless baking plates are arranged to create the desired shape. The plates may abut one another to create a fully enclosed design. The first and second support plates slide together to connect and create a swivel hinge. The clips of the support plates are used to secure the various bottomless baking plates together so that the baking plates connect, thereby creating a seal. This will allow the food matter to remain inside the shape and bake.

Once the shape has been created, the inside walls of the baking plates may be coated with a cooking spray or butter and flour. This will help to prevent the baking matter from sticking to the shape and allow for easy removal of the food item from the shapes once it has finished baking. Adding a piece of parchment paper cut to the same length and height of the plates may be placed in between the various baking plates and support plates, which adds an additional layer of protection providing a tight seal.

The material used for the support and baking plates are oven safe and can be made with anodized aluminum, stainless steel, silicone, copper or any other material that is rigid and heat resistant to temperatures of up to 450 degrees. The material may be made from heat treated aluminum or other hard material that is safe for baking and holds a shape.

A method of using the present invention may include the following. Line a flat baking tray with parchment paper or other heat resistant material that is used for baking. Arrange any combination and amount of the bottomless baking plates to create a shape. The baking plates are touching each other on each end. Slide the first and second support plates together about the hinge. Use the clip of the support plates to connect each of the baking plates together. The baking plates are tightly joined together, forming a tight seal. Spray the inside of the baking plates with cooking spray or butter and flour. Place parchment paper against the baking plates. Place the baking matter inside the center of the shape slowly. Once filled do not move the shape as this may cause the matter to leak. Place the tray in the oven and bake until completion. When finished baking remove the tray from the oven and allow the food to cool until the shapes are safe to touch without risk of injury. Disconnect the first and second support plates and remove the baking plates from the finished product.

In alternate embodiments, the present invention can be used to help create the shape of cold foods that need to be refrigerated such as ice cream. It can also be used to assist in presentation when creating a shape on a dish of food that is to be served such as rice, pasta or salad.

It should be understood, of course, that the foregoing relates to exemplary embodiments of the invention and that modifications may be made without departing from the spirit and scope of the invention as set forth in the following claims.

What is claimed is:

1. An interchangeable baking device comprising:
a first support plate having a top end and a bottom and comprising a substantially flat front surface, wherein a first clip is formed at the top end;
a second support plate connectable to the first support plate and having a top end and a bottom and comprising a substantially flat front surface, wherein a second clip is formed at the top end; and
at least one baking plate comprising a substantially flat body and securable in an upright position within the first and second clips forming a baking enclosure.

2. The interchangeable baking device of claim 1, wherein the first support plate and the second support plate are hingedly connected.

3. The interchangeable baking device of claim 1, wherein the first support plate and the second support plate are connectable such that the front surface of the first support plate is planar with the front surface of the second support plate.

4. The interchangeable baking device of claim 1, wherein the first support plate comprises a peg extending from a side and away from the front surface, and the second support comprises a receiver extending from an adjacent side to the side of the first support plate and extending away from the front surface, wherein the peg and the receiver hingedly connect.

5. The interchangeable baking device of claim 4, wherein the at least one baking plate comprise a plurality of curved plates and a plurality of flat plates, wherein the plurality of curved plates each comprise a different radius of curvature, and the plurality of flat plates each comprise a different length.

6. A method of forming an interchangeable baking mold comprising:
providing a plurality of supporting devices each comprising at least one clip;
providing a plurality of baking plates; and
securing the baking plates to the clips of the supporting devices so that the baking plates are in an upright position, and forming a baking enclosure in between the baking plates.

7. The method of claim 6, wherein securing the baking plates to the clips of the supporting device comprises the following steps:
securing a first end of a first baking plate within a clip of a first supporting device;
securing a second end of the first baking plate within a clip of a second support device, thereby suspending the first baking plate in an upright position;
securing a first end of a second baking plate within the clip of the first supporting device; and
securing a second end of the second baking plate within a clip of a second support device.

8. The method of claim 6, wherein each of the supporting devices comprise:
a first support plate having a top end and a bottom and comprising a substantially flat front surface, wherein a first clip is formed at the top end; and
a second support plate having a top end and a bottom and comprising a substantially flat front surface, wherein a second clip is formed at the top end,
wherein the first support plate and the second support plate are connectable such that the front surface of the first support plate is planar with the front surface of the second support plate.

9. The method of claim 8, wherein the first support plate and the second support plate are hingedly connected.

10. The method of claim 9, wherein the first support plate comprises a peg extending from a side and away from the front surface, and the second support comprises a receiver extending from an adjacent side to the side of the first support plate and extending away from the front surface, wherein the peg and the receiver hingedly connect.
